(19) United States
(12) Patent Application Publication
(10) Pub. No.: US 2016/0381452 A1
(43) Pub. Date: Dec. 29, 2016

(54) Stand-alone headphones with digital music player

(71) Applicants: Robert Rodriguez, Bridgeport, CT (US); Veronica Rodriguez, Bridgeport, CT (US)

(72) Inventors: Robert Rodriguez, Bridgeport, CT (US); Veronica Rodriguez, Bridgeport, CT (US)

(21) Appl. No.: 15/194,519

(22) Filed: Jun. 27, 2016

Related U.S. Application Data
(60) Provisional application No. 62/184,538, filed on Jun. 25, 2015.

(51) Int. Cl. H04R 1/10

(52) U.S. Cl. CPC H04R 1/1058; H04R 1/1091; H04R 1/1041; H04R 2420/09; H04R 2201/103

(57) ABSTRACT

Stand-alone headphones with a digital music player provide a complete, internalized digital music playing system with a micro-SD card slot, two LCD visual displays, and an internal memory device for the storage of audio files. A microphone and voice recognition software enable the headphones to be controlled by voice commands. A separate volume control is provided for each headphone. A Universal Service Bus (USB) port enables transfer of audio files between the memory device and any external device, as well as recharging the battery.

### CROSS-REFERENCES TO RELATED APPLICATIONS (IF ANY)

This application claims the priority date of Provisional Application No. 62/184,538 filed on Jun. 25, 2015.

### BACKGROUND

1. Field of the Invention

The invention relates generally to digital music players and accessories, and in particular to stand-alone headphones with a digital music player.

2. Description of Prior Art

The MP3 format, and other digital music formats, have spawned a broad range of music playing devices which have substantially altered the pastime of listening to music and other audio recordings. Unfortunately, headphones have always provided as a separate component from the music player, which may be a dedicated device, or a smartphone or other device with a secondary music-playing feature. The music player may become a distraction, whether it is carried in the user's pocket, on an armband, or in some other form of stowage. Stand-alone headphones with a digital music player, which provide all the necessary components for listening to digital recordings within a pair of headphones, would resolve this problem.

There is still room for improvement in the art.

### SUMMARY OF THE INVENTION

Accordingly, the invention is directed to stand-alone headphones with a digital music player. The headphones provide a complete, internalized digital music playing system with a micro-SD card slot, two LCD visual displays, and an internal memory device for the storage of audio files. A microphone and voice recognition software enable the headphones to be controlled by voice commands. A separate volume control is provided for each headphone. A Universal Service Bus (USB) port enables transfer of audio files between the memory device and any external device, as well as recharging the battery.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

The current invention is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 is a front view of the first exemplary embodiment, displaying the headphones 10, the right headphone 10A, the left headphone 10B, and the headband 11;

FIG. 2 is a right side view of the first exemplary embodiment, displaying the headphones 10, the right headphone 10A, the headband 11, the power switch 12, the touchscreen visual display 13A, the microphone 14, and the volume control 15;

FIG. 3 is a left side view of the first exemplary embodiment, displaying the headphones 10, the left headphone 10B, the headband 11, the standard visual display 13B, the volume control 15, the micro-SD card slot 16, the USB port 17, and the control buttons 18;

FIG. 4 is a left side perspective view of the first exemplary embodiment, displaying the headphones 10, the right headphone 10A, the left headphone 10B, the headband 11, the standard visual display 13B, and the volume control 15; and

FIG. 5 is a right side perspective view of the first exemplary embodiment, displaying the headphones 10, the right headphone 10A, the left headphone 10B, the headband 11, the power switch 12, the touchscreen visual display 13A, the microphone 14, and the volume control 15; and

FIG. 6 is a schematic of the internal components.

### DESCRIPTION OF THE PREFERRED EMBODIMENT

There are a number of significant design features and improvements incorporated within the invention.

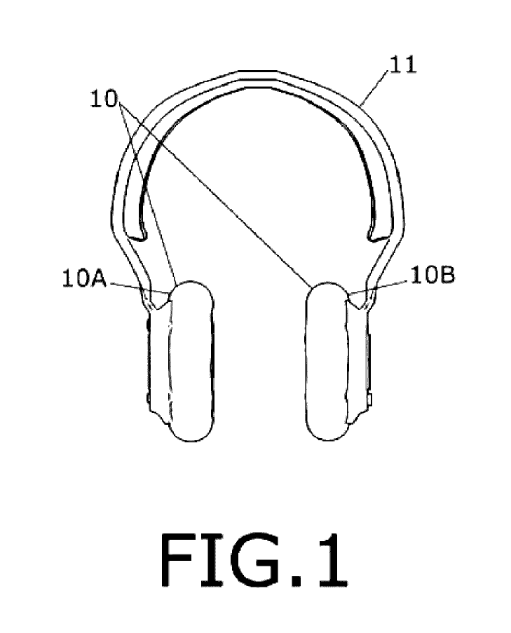

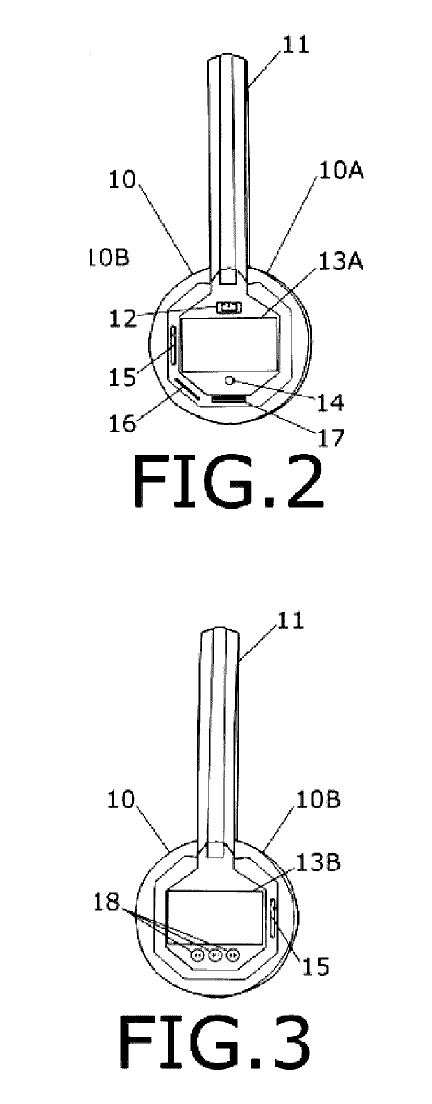

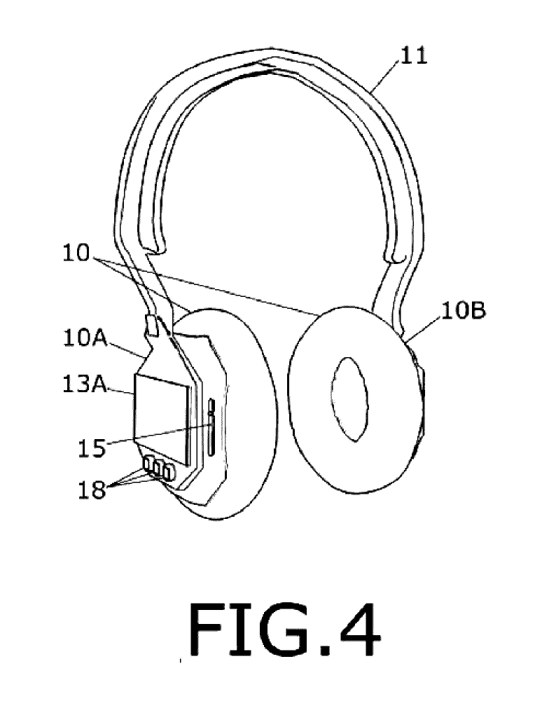

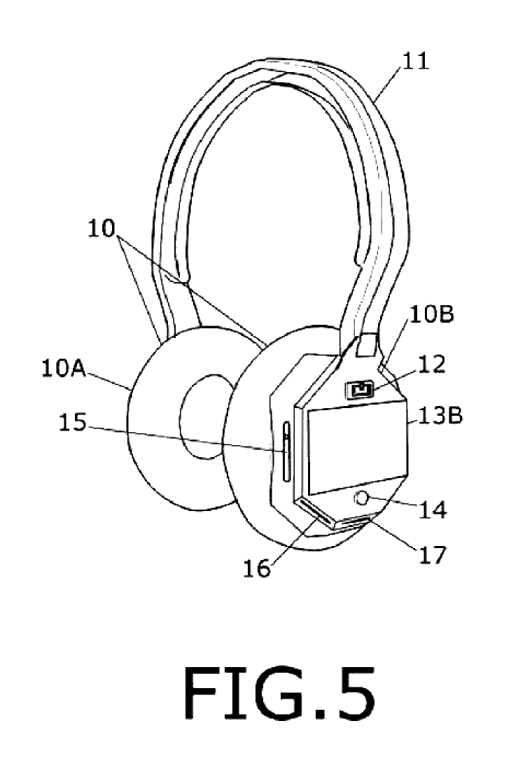

As shown in FIG. 1 through 5, the current invention is directed to stand-alone headphones 10 with a digital music player.

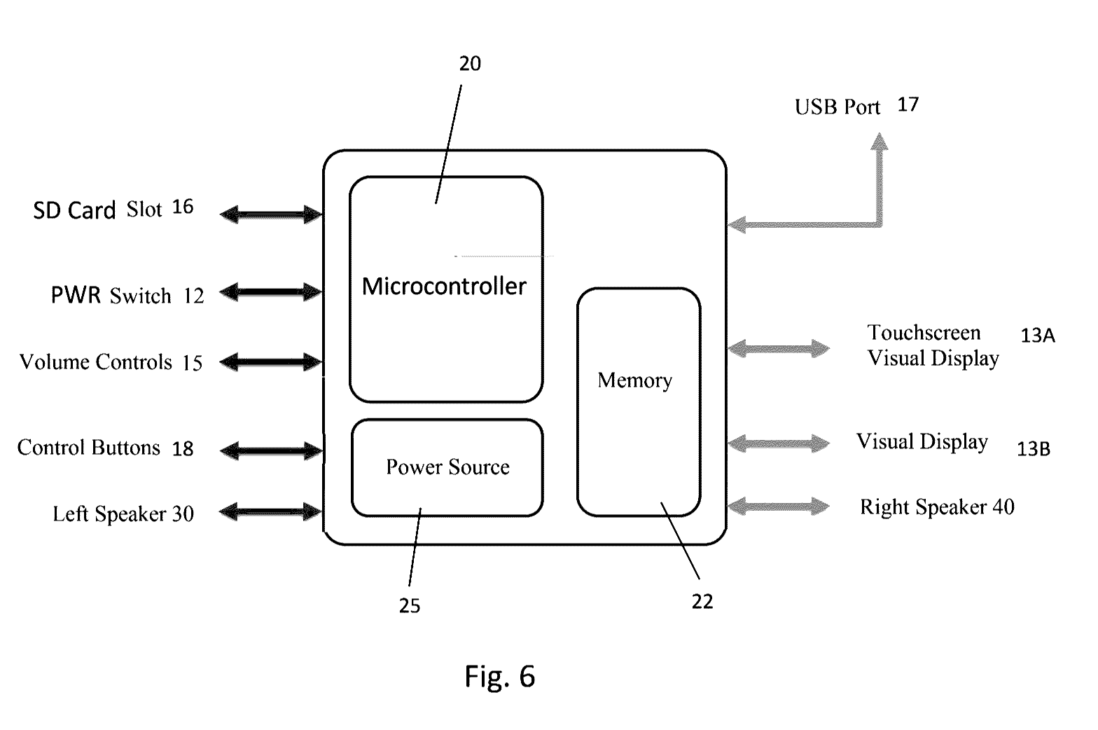

The first exemplary embodiment is comprised of headphones 10 which provide a complete, internalized digital music playing system, using the MP3 digital protocol or any one of several other digital audio protocols. As shown in FIG. 6, the headphones 10 provide a microprocessor 20 and an internal memory device 22 for the storage of audio files, and a rechargeable battery 25, although other power sources such as normal batteries can be used.

The right headphone 10A provides a power switch 12, a touchscreen visual display 13A, and a small microphone 14 for voice commands. The left headphone 10B provides a standard visual display 13B, a micro-SD card slot 16 such that audio files may be played directly from a micro-SD card, and a Universal Service Bus (USB) port 17, which enables transfer of audio files between the memory device 22 and any external device, as well as recharging the battery 25. Conventional control buttons 18 are provided for fast-forward, pause, and rewind functions.

Optionally, the USB port 17 may be provided in an internal compartment, such that a flash drive may be carried securely within the compartment while connected to the USB port 17, and audio files may be played directly from the flash drive. Optionally, the headphones 10 may be capable of being temporarily affixed to a docking station with conventional speakers, providing audio content to the docking station and recharging the battery from power supplied by the docking station. The microphone 14 is supported by voice recognition software which enables the headphones 10 to be controlled by voice commands. Separate volume controls 15, preferably small slide switches, are provided on the right headphone 10A and the left headphone 10B.

Electronic components preferably include two speakers, a left speaker 30 and a right speaker 40, a microphone 14, a power switch 12, two volume controls 15, a touchscreen visual display 13A, a standard visual display 13B, a micro-SD card slot 16, a USB port 17, a rechargeable battery, a microprocessor, and a memory device. The components are connected to the battery and the microprocessor.

To use the first exemplary embodiment, the user may activate the power switch 12 and transfer digital music files and other digital audio files to the memory device, using the micro-SD card slot 16 or the USB port, which are provided. Alternately, the user may acquire audio content directly from a micro-SD card, using the micro-SD card slot, or a flash drive, using the USB port 17. The user may then play the acquired audio content, controlling the device with voice commands using the microphone 14, the volume controls 15, and the control buttons 18.

The headphones 10 are preferably manufactured from rigid, durable materials which are corrosion resistant, such as steel, brass, plastic, and aluminum alloy, providing ear pads which are preferably manufactured from a flexible, durable material such as foam rubber, covered by a flexible, durable material such as leather, vinyl, or plastic. The headband 11 is preferably manufactured from a semi-rigid, durable material such as spring steel, covered by a flexible, durable material such as silicon or plastic.

The power switch 12, the microphone 14, the volume controls 15, the micro- SD card slot 16, the USB port 17, and the control buttons 18 are preferably manufactured from rigid, durable materials such as plastic, steel, aluminum alloy, brass, and copper alloy. The touchscreen visual display 13A and the standard visual display 13B are preferably manufactured from a rigid, durable material which is transparent, such as plastic or malacrylate.

Components, component sizes, and materials listed above are preferable, but artisans will recognize that alternate components and materials could be selected without altering the scope of the invention.

While the methods disclosed herein have been described and shown with reference to particular steps performed in a particular order, it is understood that these steps may be combined, sub-divided, or reordered to form an equivalent method without departing from the teachings of the embodiments. Accordingly, unless specifically indicated herein, the order and grouping of the steps is not a limitation of the embodiments. Furthermore, methods and mechanisms of the embodiments will sometimes be described in singular form for clarity. However, some embodiments may include multiple iterations of a method or multiple instantiations of a mechanism unless noted otherwise. For example, when a connection is disclosed in one embodiment, the scope of the embodiment is intended to also cover the use of multiple connections. Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination. Embodiments described in conjunction with specific examples are presented by way of example, and not limitation. Moreover, it is evident that many alternatives, modifications, and variations will be apparent to those skilled in the art. It is to be understood that other embodiments may be utilized and structural changes may be made without departing from the scope of the embodiments.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A pair of headphones comprising:
a right headphone with a speaker and a left headphone with a speaker connected by a headband with a microprocessor connected to an internal memory device and power source.

2. A pair of headphones according to claim 1 comprising:
having audio files stored on the internal memory device.

3. A pair of headphones according to claim 1 comprising:
having a power switch 12;

4. A pair of headphones according to claim 1 comprising:
having a micro-SD card slot.

5. A pair of headphones according to claim 1 comprising:
having a USB port.

6. A pair of headphones according to claim 1 comprising:
digital files are transferred to the memory device.

7. A pair of headphones according to claim 6 comprising:
where the digital files are audio files.

8. A pair of headphones according to claim 4 comprising:
digital files are transferred to the memory device using the SD card slot.

9. A pair of headphones according to claim 5 comprising:
digital files are transferred to the memory device using the USB port.

10. A pair of headphones according to claim 1 comprising:
having a microphone.

11. A pair of headphones according to claim 10 comprising:
giving voice commands using the microphone.

12. A pair of headphones according to claim 1 comprising:
having volume controls.

13. A pair of headphones according to claim 1 comprising:
having control buttons.

14. A pair of headphones according to claim 1 comprising:
having a touchscreen visual display.

15. A pair of headphones according to claim 1 comprising:
having a visual display.

16. A pair of headphones according to claim 1 comprising:
having the right headphone having a power switch, a touchscreen visual display and a microphone.

17. A pair of headphones according to claim 1 comprising:
having the left headphone having a visual display, a micro-SD card slot, and a USB port.

18. A pair of headphones according to claim 1 comprising:
having the right headphone having a power switch, a touchscreen visual display and a microphone and the left headphone having a visual display, a micro-SD card slot, and a USB port.

19. A pair of headphones according to claim 18 comprising:
having audio files played directly from the micro-SD card.

20. A pair of headphones according to claim 18 comprising:
using the USB port to transfer files and to recharge the battery.
